(19) United States
(12) Patent Application Publication
(10) Pub. No.: US 2012/0162809 A1
(43) Pub. Date: Jun. 28, 2012

(54) MAGNETIC DISK DRIVE AND METHOD OF ACCESSING A DISK IN THE DRIVE

(75) Inventor: Ikuko IIDA, Ome-shi (JP)

(73) Assignee: KABUSHIKI KAISHA TOSHIBA, Tokyo (JP)

(21) Appl. No.: 13/245,669

(22) Filed: Sep. 26, 2011

(30) Foreign Application Priority Data
Dec. 27, 2010 (JP) 2010-290995

(51) Int. Cl. G11B 15/18

(52) U.S. Cl. 360/71; G9B/15.021

(57) ABSTRACT

According to one embodiment, a magnetic disk drive includes a disk, a determination module, and a controller. The determination module is configured to determine whether access to the disk requires data transfer between a host and the magnetic disk drive in accessing the disk. The controller is configured to control disk access according to a predetermined allocation of consecutive second logical addresses corresponding to physical addresses indicative of consecutive physical locations on the disk if the data transfer is not required. The second logical addresses are addresses different from first logical addresses recognized by the host.

### CROSS-REFERENCE TO RELATED APPLICATIONS

This application is based upon and claims the benefit of priority from prior Japanese Patent Application No. 2010-290995, filed Dec. 27, 2010, the entire contents of which are incorporated herein by reference.

### FIELD

Embodiments described herein relate generally to a magnetic disk drive and a method of accessing a disk in the drive.

### BACKGROUND

A host using a magnetic disk drive generally specifies an access destination with a logical address when accessing the magnetic disk drive. Suppose consecutive logical addresses have been allocated to, for example, consecutive tracks in a first area on a disk. In this state, suppose the host has requested the magnetic disk drive to rewrite data in a second area, a part of the first area (more specifically, in a logical address area corresponding to the second area).

A conventional magnetic disk drive that uses the following method to rewrite data has been known. The method is to write new data into a third area differing from the second area on the disk instead of rewriting data itself stored in the second area.

It is assumed that new data has been written in the third area by the above method. In this case, the allocation destination of logical addresses allocated to the second area is changed from the second area to the third area. Then, the data in the second area is invalidated. That is, the mapping of logical addresses and physical addresses is changed.

In this state, suppose the host has requested access to a logical address area allocated to the first area before the data in the second area was invalidated. In this case, when an access destination has reached the second area in the first area, the access is changed to access to the third area.

With the conventional magnetic disk drive, when the data has been rewritten repeatedly, tracks on the disk to which consecutive logical addresses are allocated (more specifically, physical addresses indicating the physical locations of tracks) become physically nonconsecutive. Therefore, with the conventional magnetic disk drive, nonconsecutive physical locations on the disk are accessed frequently. To access the nonconsecutive physical locations, a seek operation for moving the head to the nonconsecutive physical locations is needed. However, depending on the purpose of disk access, the disk may be accessed based on the correspondence between logical addresses and physical addresses before the change of the mapping.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram showing an exemplary configuration of an electronic device including a magnetic disk drive according to an embodiment;

FIG. 2 is a conceptual diagram showing a format including a track arrangement of a disk applied to the embodiment;

FIG. 3 shows an example of physical addresses of consecutive tracks on the disk;

FIG. 4 shows an example of the relationship between logical addresses and physical addresses in a state where data has been written on consecutive tracks on the disk by shingled writing;

FIG. 5 shows an example of the relationship between logical addresses and physical addresses after data on one of consecutive tracks on the disk has been rewritten using another track;

FIG. 6 shows an example of the relationship between logical addresses and physical addresses on consecutive tracks on the disk after data has been rewritten repeatedly;

FIG. 7 is a diagram to explain an example of a default address arrangement applied to the embodiment;

FIG. 8 shows an example of a primary defect management table applied to the embodiment;

FIG. 9 is a flowchart to explain an exemplary processing procedure of the magnetic disk drive when a command involving disk access is given by the host in the embodiment; and

FIG. 10 shows an example of the relationship between management logical addresses and physical addresses in a default address arrangement.

### DETAILED DESCRIPTION

Various embodiments will be described hereinafter with reference to the accompanying drawings. In general, according to one embodiment, a magnetic disk drive comprises (includes) a disk, a determination module, and a controller. The determination module is configured to determine whether access to the disk requires data transfer between a host and the magnetic disk drive in accessing the disk. The controller is configured to control disk access according to a predetermined allocation of consecutive second logical addresses corresponding to physical addresses indicative of consecutive physical locations on the disk if the data transfer is not required. The second logical addresses are addresses different from first logical addresses recognized by the host.

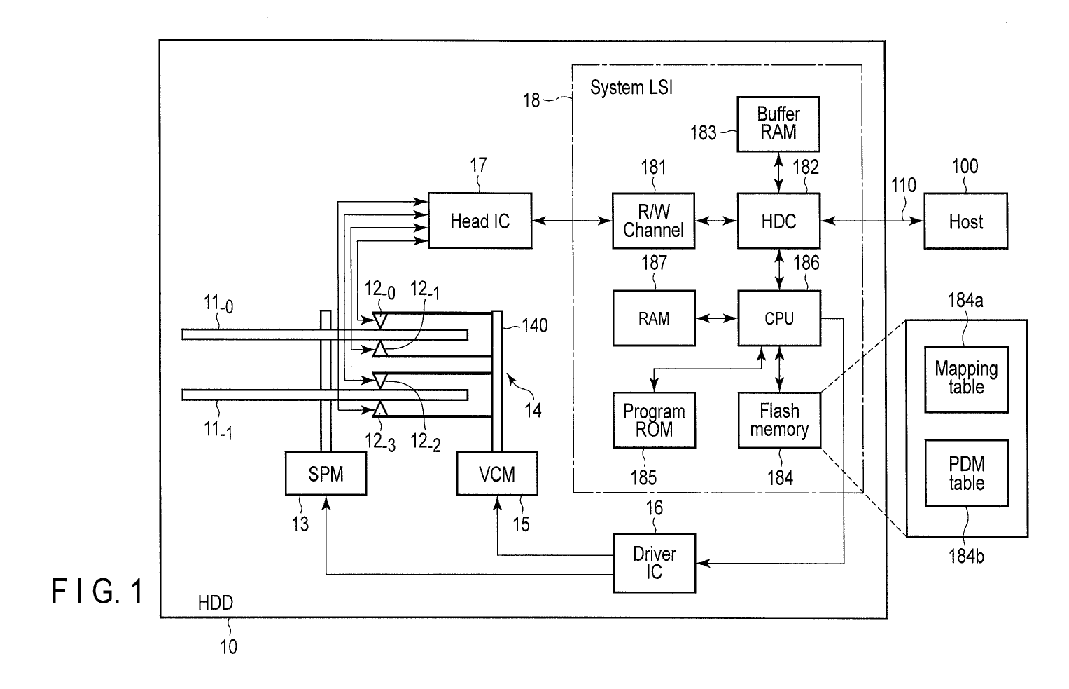

FIG. 1 is a block diagram showing an exemplary configuration of an electronic device including a magnetic disk drive according to an embodiment. In FIG. 1, the electronic device comprises a magnetic disk drive (hereinafter, referred to as an HDD) 10 and a host 100. In the embodiment, the electronic device is a personal computer. However, the electronic device need not necessarily be a personal computer and may be an electronic device other than a personal computer, such as a video camera, a music player, a mobile terminal, a mobile phone, or a printing device. The host 100 uses the HDD 10 as a storage device of the host 100. The host 100 is connected to the HDD 10 with a host interface 110.

In the embodiment, the HDD 10 uses a known shingled write technique. The HDD 10 comprises disks (magnetic disks) 11-0 and 11-1, heads (magnetic heads) 12-0 to 12-3, a spindle motor (SPM) 13, an actuator 14, a voice coil motor (VCM) 15, a driver IC 16, a head IC 17, and a system LSI 18.

The disks 11-0 and 11-1, which are magnetic recording mediums, are stacked one on top of the other with a specific clearance between them. Each of the disks 11-0 and 11-1 has an upper disk surface and a lower disk surface. In the embodiment, each of the disk surfaces makes a recording surface on which data is to be recorded magnetically. The disks 11-0 and 11-1 are rotated by the SPM 13 at high speed. The SPM 13 is driven by a driving current (or driving voltage) supplied from the driver IC 16. The HDD 10 may comprise a single disk.

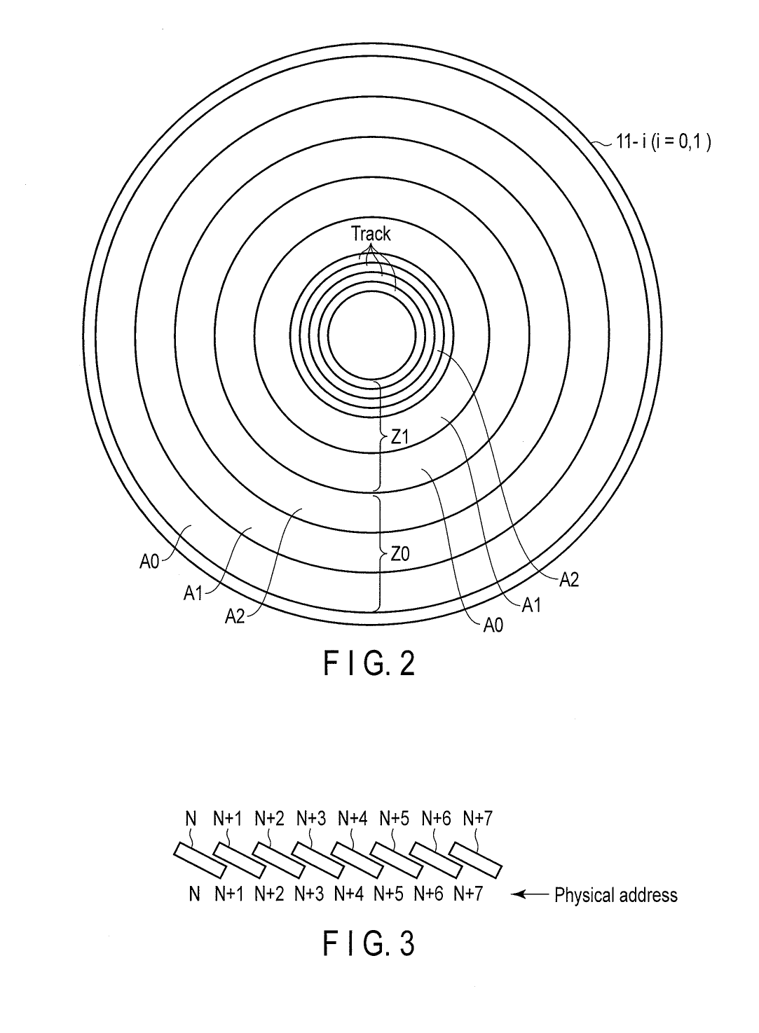

FIG. 2 is a conceptual diagram showing an example of a format including a track (cylinder) arrangement of a disk 11-i (i=0, 1) applied to the embodiment. The HDD 10 uses constant density recording (CDR). Therefore, the disk surface of the disk 11-i is divided into a plurality of zones in the direction of radius of the disks 11-i for management. In the example of FIG. 2, suppose the disk surface of the disk 11-i is divided into two zones, Z0 and Z1, for management. That is, the disk 11-i has zones Z0 and Z1. In zones Z0 and Z1, the track density TPI is constant. In contrast, the linear recording density (the number of sectors per track), which differs between zones Z0 and Z1, is larger in zone Z0 closer to the outer edge. That is, the number of sectors (recording capacity) per track differs from zone to zone. The disk 11-i may include more than two zones. Zones Z0 and Z1 are identified by zone numbers 0 and 1, respectively. In the explanation below, zones Z0 and Z1 may be written as zones 0 and 1.

Each of zones Z0 and Z1 is divided into a plurality of areas called roofs for management. In an example of FIG. 2, for convenience of drawing, suppose each of zones Z0 and Z1 is divided into three areas, A0, A1, and A2 for management. That is, in the embodiment, each of zones Z0 and Z1 includes areas A0 to A2. Each of areas A0 to A2 in zone Zp (p=0, 1) includes a predetermined number of tracks. In FIG. 2, for the purpose of convenience, only tracks included in area A3 in zone Z1 are shown and those included in the remaining areas are omitted.

In the embodiment, at least one of areas A0 to A2 in zone Zp, for example, one, is used as a spare area. In the shingled writing, the spare area is used as a move destination (rewrite destination) of data on each track in another area in a corresponding zone Zp. When the data movement (rewrite) has been completed, the source area of the data is newly changed to a spare area.

In FIG. 1, heads 12-0 and 12-1 are arranged in association with the upper and lower disk surfaces respectively and heads 12-2 and 12-3 are arranged in association with the upper and lower disk surfaces respectively. Heads 12-0 to 12-3 and the disk surfaces corresponding to heads 12-0 to 12-3 are identified by head numbers 0 to 3. Each of heads 12-0 to 12-3 includes a read element and a write element (both not shown). Heads 12-0 to 12-1 are used to write data onto the upper and lower disk surfaces of disk 11-0 respectively and read data from the upper and lower disk surfaces of disk 11-0 respectively. Heads 12-2 to 12-3 are used to write data onto the upper and lower disk surfaces of disk 11-1 respectively and read data from the upper and lower disk surfaces of disk 11-1 respectively.

Heads 12-0 to 12-3 are attached to the tip of the actuator 14. More specifically, heads 12-0 to 12-3 are attached to the tips of suspensions extending from four arms the actuator 14 has. The actuator 14 is supported so as to angularly move around an axis 140. The actuator 14 includes the VCM 15. The VCM 15 is used as a driving source for the actuator 14. The VCM 15 is driven by a driving current (or driving voltage) supplied from the driver IC 16, thereby angularly moving the actuator 14 around the axis 140. This makes heads 12-0 to 12-3 move in the direction of radius of disks 11-0 and 11-1.

The driver IC 16 drives the SPM 13 and VCM 15 under the control of a CPU 186 (described later) in the system LSI 18. The head IC 17 amplifies a signal (read signal) read by head 12-j (j=0, 1, 2, 3). The head IC 17 also converts write data transferred from an R/W channel (described later) 181 in the system LSI 18 into a write current and outputs the write current to head 12-j.

The system LSI 18 is an LSI called System-on-Chip (SOC) in which a plurality of elements have been squeezed into a single chip. The system LSI 18 comprises a read/write channel (R/W channel) 181, a disk controller (hereinafter, referred to as a HDC) 182, a buffer RAM 183, a flash memory 184, a program ROM 185, a CPU 186, and a RAM 187.

The R/W channel 181 is a known signal processing device configured to process signals related to read/write operations. The R/W channel 181 digitizes a read signal and decodes read data from the digitized data. The R/W channel 181 also extracts servo data necessary to position head 12-j from the digital data. The R/W channel 181 also encodes write data.

The HDC 182 is connected to the host 100 via a host interface 110. The HDC 182 receives a command (e.g., write command or read command) transferred from the host 100. The HDC 182 controls data transfer between the host 100 and the HDC 182. The HDC 182 controls data transfer between disk 11-i and the HDC 182

The buffer RAM 183 includes a buffer area that temporarily stores data to be written onto disk 11-i and data read from disk 11-i via the head IC 17 and R/W channel 181. To speed up table reference at the time of turning on the power of the HDD 10, the buffer RAM 183 further includes a table area into which a mapping table 184a and a PDM table 184b (both described later) are to be loaded from a flash memory 184. However, in the explanation below, for the sake of simplification, suppose the mapping table 184a and PDM table 184b are referred to in a state where they have been stored in the flash memory 184.

The flash memory 184 is a rewritable nonvolatile memory. The flash memory 184 is used to store the mapping table 184a and primary defect management (PDM) table 184b. The mapping table 184a and PDM table 184b will be described later. The program ROM 185 stores a control program (firmware program) in advance. The control program may be stored in a part of the flash memory 184.

The CPU 186 functions as a main controller of the HDD 10. The CPU 186 controls at least a part of the rest of the HDD 10 according to the control program stored in the program ROM 185. A part of the RAM 187 is used as a work area of the CPU 186.

Next, the principle of shingled writing applied to the embodiment will be explained with reference to FIGS. 3 to 6. FIGS. 3 to 6 schematically show a part of the surface of disk 11-i. FIGS. 3 to 6 show eight physically consecutive tracks N, N+1, N+2, . . . , N+7 on disk 11-i. In FIGS. 3 to 6, ring-shaped tracks are represented as rectangles for the purpose of convenience. Suppose the physical addresses of tracks N, N+1, N+2, . . . , N+7 are N, N+1, N+2, . . . , N+7, respectively.

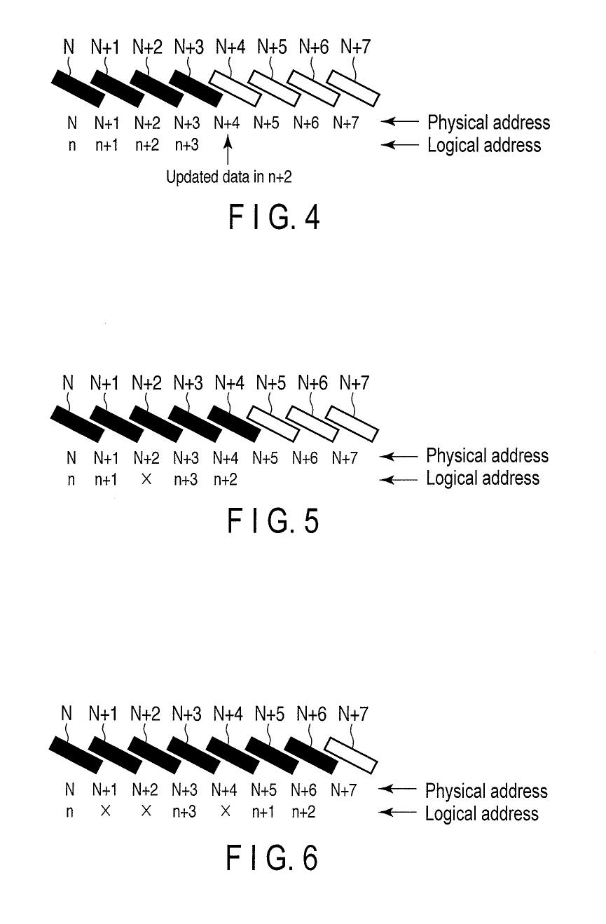

FIG. 3 shows a state where valid data has not been stored on tracks N, N+1, N+2, . . . , N+7. In the state of FIG. 3, suppose an instruction to write data into a logical address area corresponding to, for example, consecutive logical addresses n, n+1, n+2, and n+3 (i.e., data in logical addresses n, n+1, n+2, and n+3) has been given according to a write (write access) request from the host 100. In addition, as shown in FIG. 4, suppose logical addresses n, n+1, n+2, and n+3 have been allocated to tracks N, N+1, N+2, and N+3. In this case, the CPU 186 controls the writing of data onto tracks N, N+1, N+2, and N+3 by shingled writing.

Information indicating the relationship between logical addresses and physical addresses is stored in the mapping table 184a. Referring to the mapping table 184a, the CPU 186 can determine tracks N, N+1, N+2, and N+3 with physical addresses N, N+1, N+2, and N+3 respectively to which logical addresses n, n+1, n+2, and n+3 have been allocated respectively. Here, to simplify explanation, suppose a logical address has been allocated to each track. However, it is common practice to allocate a logical address (LBA) to each sector on a track. A physical address of each track is composed of cylinder number C and head number H. A physical address of each sector on a track is composed of cylinder number C, head number H, and sector number S.

In the embodiment, the physical address of each track on the upper disk surface of disk 11-0 corresponding to head 12-0 includes head number 0 (H=0) and the physical address of each track on the lower disk surface of disk 11-0 corresponding to head 12-1 includes head number 1 (H=1). Similarly, the physical address of each track on the upper disk surface of disk 11-1 corresponding to head 12-2 includes head number 2 (H=2) and the physical address of each track on the lower disk surface of disk 11-1 corresponding to head 12-3 includes head number 3 (H=3).

As is commonly known, the track width is narrower than the head width in shingled writing. To simplify explanation, suppose the track width is half the head width. In this case, for example, to write data in logical address n+1 onto track N+1 after data in logical address n has been written onto track N, head 12-j is shifted toward track N+1 by half the head width. After this shift, head 12-j writes data in logical address n+1 onto track N+1. Then, similarly, data in logical address n+2 is written onto track N+2. Thereafter, data in logical address n+3 is written onto track N+3.

FIG. 4 shows a state where data in logical addresses n, n+1, n+2, and n+3 requested by the host 100 have been written onto tracks N, N+1, N+2, and N+3. In the state of FIG. 4, suppose the host 100 has requested the HDD 10 to rewrite data in, for example, logical address n+2. At this time, as shown in FIG. 4, logical address n+2 has been allocated to track N+2 whose physical address N+2.

As described above, data is written onto tracks N, N+1, N+2, and N+3 by so-called partial overwriting. Therefore, if data (e.g., A) on track N+2 to which logical address n+2 has been allocated is rewritten with data (e.g., B) requested by the host 100 this time, data on, for example, track N+3 next to track N+2 is also rewritten.

Therefore, in the HDD 10 using shingled writing, data B is written on a track differing from track N+2 instead of rewriting data A on track N+2 with data B. In an example of FIG. 4, suppose data (update data) is written on track N+4. If a part of data A, “a”, is rewritten with b, data A is read from track N+2 and data (update data) B obtained by replacing a part of data A, “a”, with b is written onto track N+4.

Thereafter, the allocation destination of logical address n+2 is changed from track N+2 to track N+4 (i.e., track N+4 on which data B has been written). The state of tracks N, N+1, N+2, . . . , N+7 at this time is shown in FIG. 5. In FIG. 5, track N+2 shown by symbol x indicates a track whose allocation of a logical address has been cancelled as a result of the change of the allocation destination of logical address n+2. The CPU 186 reflects the change of the allocation destination of logical address n+2 in the mapping table 184a.

Suppose, after the state of FIG. 5, data in logical address n+1 is rewritten and then data in logical address n+2 is rewritten again. The state of tracks N, N+1, N+2, . . . , N+7 at this time is shown in FIG. 6. In the state of FIG. 6, data in logical addresses n, n+3, n+1, n+2 have been written onto tracks N, N+3, N+5, and N+6, respectively. That is, data in consecutive logical addresses n, n+1, n+2, and n+3 have been written onto tracks N, N+5, N+6, and N+3 whose physical addresses are nonconsecutive. In addition, tracks N+1, N+2, and N+4 in which data had been written have become tracks whose allocation of logical addresses has been cancelled as a result of data rewrite as shown by symbol x in FIG. 6.

Suppose, in the state of FIG. 6, the host 100 has requested the HDD 10 to read data in, for example, logical address n+1. In this case, the CPU 186 obtains physical address N+5 corresponding to logical address n+1 based on referring to the mapping table 184a. Then, the CPU 186 controls the reading of data from track N+5 with physical address N+5. The data read from track N+5 is transferred by the HDC 182 to the host 100.

Here, suppose the host 100 has requested the HDD 10 to read data in consecutive logical addresses n, n+1, n+2, n+3, and n+4. In this case, although the logical addresses are consecutive, they are not accessed sequentially on disk 11-i. That is, in addition to a seek operation for moving head 12-j to the beginning track N, a seek operation for moving head 12-j from track N to track N+5, and a seek operation for moving head 12-j from track N+6 to track N+3 take place. Therefore, it takes time to read data. Moreover, as is commonly known, there is a skew in each track. Accordingly, when access is not provided sequentially, there is a rotational delay after a seek operation, with the result that it takes much more time to read data.

In the commands (requests) given from the host 100 to the HDD 10, there is a command to specify an operation that does not require data to be transferred to the host 100 as in a scan test for checking, for example, a predetermined logical address area. To simplify the explanation, suppose the predetermined logical address area is a logical address area specified by logical addresses n to n+4.

A self test in Self-Monitoring Analysis and Reporting Technology (SMART) that scans the entire disk surface of a disk to check the disk surface is known as a command requiring a scan test. In a self test in SMART, the HDD 100 has to inform the host 100 in advance of the time required for a scan test. When physical addresses corresponding to logical addresses n to n+4 are nonconsecutive as described above (see FIG. 6), it is difficult to execute a scan test in a specific time. In this case, the difference between the time actually required for a scan test and the time previously reported to the host 100 by the HDD 10 becomes large. That is, when physical addresses corresponding to logical addresses n to n+4 are nonconsecutive, the scan test is not efficient in terms of performance and the time required for the scan test cannot be estimated.

In the case of a command which specifies such an operation as a scan test that does not require the HDD 10 to transfer data to the host 100 (an operation involving disk access), corresponding tracks need not necessarily be accessed in the order of logical addresses n to n+4. Therefore, it is conceivable that a scan test is executed in the order of physical addresses as follows: tracks N, N+1, N+2, . . . . Here, tracks with defect sectors (primary defect sectors) detected in manufacturing, for example, the HDD 10 might be included in tracks N, N+1, N+2, . . . . If a scan test is executed simply in the order of physical addresses, tracks with primary defect sectors are also accessed. In this case, an error occurs. Therefore, in a scan test, disk access that takes primary defect sectors (i.e., primary defect places) into account has to be applied.

In the embodiment, primary defect sectors are managed using the PDM table 184b. In the PDM table 184b, primary defect sectors are managed by the allocation of default logical addresses for physical addresses (hereinafter, referred to as a default address arrangement) before the HDD 10 performed control for shingled writing for the first time.

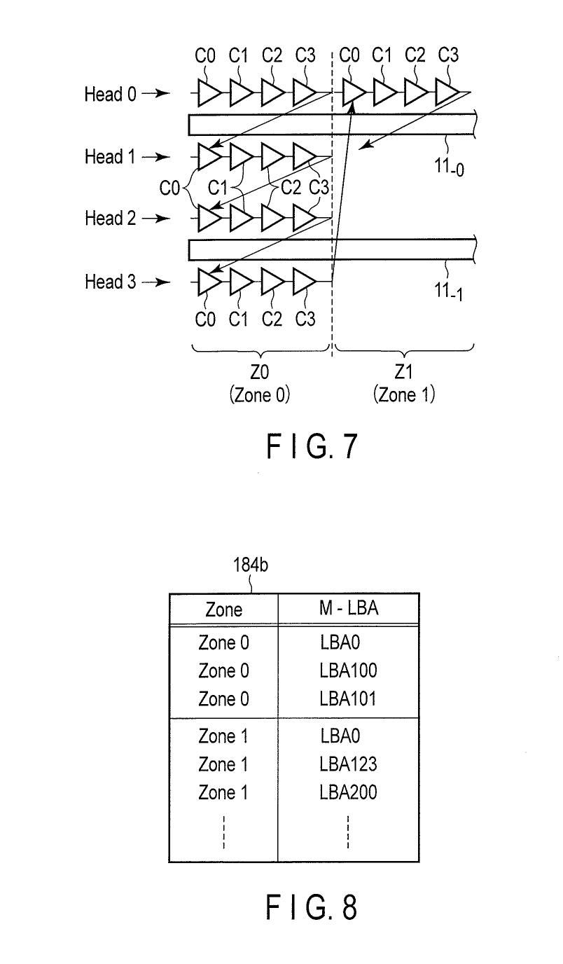

A default address arrangement in the embodiment will be explained with reference to FIG. 7. First, logical addresses are allocated in ascending order in the sector direction on track [0, 0] with cylinder 0 (a cylinder whose cylinder number C is 0) and head 0 (a head whose head number H is 0). The beginning logical address is represented as LBA0. Cylinder 0 is a beginning cylinder in zone Z0 whose zone number is 0 (i.e., zone 0). When logical addresses have been allocated up to the last sector on track [0, 0], cylinder number C is incremented from 0 to 1. In FIG. 7, a triangular symbol indicates a cylinder (track). In FIG. 7, each sector in a cylinder (track) is omitted.

Next, logical addresses are allocated in ascending order in the sector direction on track [1, 0] with cylinder 1 and head 0. Cylinder number C is incremented repeatedly until incremented cylinder number C has reached the last cylinder in the corresponding zone. For convenience of drawing, FIG. 7 shows a case where the last cylinder is cylinder 3. However, the last cylinder is not necessarily cylinder 3.

With head 0, when logical addresses have been allocated up to the last sector in the last cylinder (cylinder 3) in zone 0, head number H is incremented from 0 to 1. Then, logical addresses are allocated in ascending order in the sector direction on track [0, 1] with cylinder 0 and head 1. Hereinafter, with head 1, logical addresses are allocated in the same manner as with head 0.

With head 1, when logical addresses have been allocated up to the last sector in the last cylinder in zone 0, head number H is incremented from 1 to 2. Then, logical addresses are allocated in ascending order in the sector direction on track [0, 2] with cylinder 0 and head 2. Hereinafter, with head 2, logical addresses are allocated in the same manner as with head 0. In this way, logical addresses are allocated repeatedly until the head whose head number H is the largest, that is, head 3, has been reached in zone 0.

With head 3, when logical addresses have been allocated up to the last sector in the last cylinder in zone 0, zone number Z is incremented from 0 to 1. Then, logical addresses are allocated in the same manner as in zone 0. As described later, in zone 1, too, logical addresses are allocated in ascending order, beginning with LBA0. Logical addresses may be allocated to sectors in zone 1, beginning with a logical address next to the logical address allocated to the last sector in the last cylinder in zone 0. The aforementioned default address arrangement is predetermined by a control program stored in the program ROM 185.

The reason why the default address arrangement is applied will be explained. In the explanation with reference to FIGS. 3 to 6, when data A on track N+2 is rewritten with data B, it is assumed that data B is written onto a track (track N+4) differing from track N+2. In this case, the mapping of logical addresses and physical addresses is changed in connection with only logical addresses allocated to track N+2. However, this assumption is made to simplify the explanation.

Actually, for example, if track N+2 belongs to area (roof) A0 in zone Z0, the mapping of logical addresses and physical addresses is changed in connection with the logical addresses allocated to all the tracks in area A0. In addition, data A on track N+2 is rewritten with data B as follows. For example, data in all the tracks in area A0 including track N+2 is read sequentially. Of the read data, data A corresponding to track N+2 is replaced with data B. That is, data on all the tracks in area A0 are merged with data B. The merged data (update data) is written (or moved) into a spare area in zone Z0 sequentially by shingled writing. The spare area is assumed to be area A2 in zone Z0. When the merged data has been written into area A2 as the spare area and the mapping has been changed, the spare area is changed from area A2 to area A0. That is, area A0 is used as a new spare area.

As described above, with the HDD 10 using shingled writing, even if data in a track Tr is rewritten, data in all the tracks in area Aq (q being any one of 0 to 2) including the track Tr have been rewritten. In addition, update data is written into a spare area in a zone to which area Aq belongs. That is, with the HDD 10 using shingled writing, data on track Tr is rewritten only in a zone to which the track Tr belongs. The reason for this is that, if the zone is changed, the recording capacity of a track differs and data cannot be rewritten in units of tracks. Therefore, in the embodiment, the concept of zone is important.

In the default logical address arrangement, after logical addresses (LBA) have been allocated in ascending order in the direction in which the cylinder number increases (i.e., in the cylinder direction) in a zone, the head number is incremented. The reason for this is as follows. Firstly, it is common practice for the host 100 (user) to use logical addresses sequentially, starting with the smallest one. Secondly, the transfer rate is higher in a zone closer to the outer edge of disk 11-i. Thirdly, data (data access) has to be prevented from concentrating on a specific head. Taking these into account, the HDD 10 of the embodiment using shingled writing employs the default address arrangement (i.e., default logical address allocation). The PDM table 184b is managed based on the default address arrangement.

On the other hand, when the host 100 has specified such an operation as a scan test that does not require data transfer between the host 100 and the HDD 10, disk access need not necessarily be provided according to logical addresses reallocated by shingled writing. Therefore, in the embodiment, the CPU 186 controls such an operation as a scan test based on the default address arrangement.

The default address arrangement remains unchanged even if logical addresses (LBA) are reallocated. A logical address applied to the default address arrangement is a logical address (a first logical address) used for management valid only in the HDD 10. The logical address (LBA) used for management is called a management logical address (M-LBA). The management logical address (M-LBA) is not recognized by the host 10. In contrast, for example, a logical address (a second logical address) specified by a read/write command from the host 100, that is, a logical address (LBA) recognized by the host 100, is called a host logical address (H-LBA).

FIG. 8 shows an example of the PDM table 184b. In the embodiment, the PDM table 184b manages primary defect sectors zone by zone using management logical addresses (M-LBAs). Here, LBA0 is used as the beginning M-LBA of each zone Zp (p=0, 1). The PDM table 184b of FIG. 8 shows that sectors whose M-LBAs are LBA0, LBA100, and LBA101 exist as primary defect sectors in zone Z0 (or zone 0). The PDM table 184b further shows that sectors whose M-LBAs are LBA0, LBA123, and LBA200 exist as primary defect sectors in zone Z1 (or zone 1).

As described above, the PDM table 184b manages primary defect sectors zone by zone using management logical addresses (M-LBAs). One reason for this is that disk 11-i is accessed in units of zones in shingled writing. Another reason is that an area to be referred to in the PDM table 184b can be determined at high speed based on a zone to be accessed.

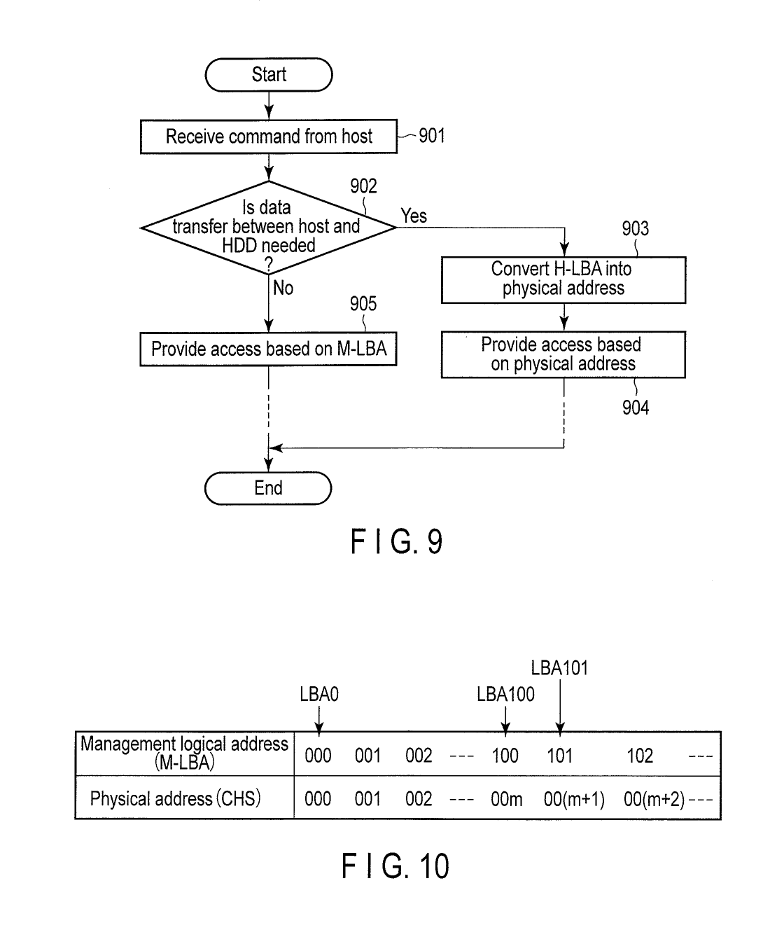

Next, an operation in the embodiment will be explained with reference to FIG. 9, taking as an example a case where the host 100 has given the HDD 10 a command involving disk access. FIG. 9 is a flowchart to explain an exemplary processing procedure (the procedure for disk access) of the HDD 10 when the host 100 has given a command involving disk access.

A command given to the HDD 10 by the host 100 is received by the HDC 182 of the HDD 10 (block 901). Then, the CPU 186, which functions as a determination module, determines whether the command received by the HDC 182 is a command that needs data transfer between the host 100 and the HDD 10 (block 902).

If the command is a command that needs data transfer (Yes in block 902), the CPU 186 functions as an address translator and converts consecutive host logical addresses (H-LBAs) in a logical address area specified by the command (a host logical address area) into corresponding physical addresses (block 903). The mapping table 184 is used in this conversion.

Next, the CPU 186 controls disk access specified by the host 100 based on physical addresses corresponding to the host logical addresses (H-LBAs) (block 904). Here, the physical addresses corresponding to the consecutive host logical addresses (H-LBAs) may be nonconsecutive as a result of the repetition of shingled writing.

As described above, in the case of disk access that requires data transfer between the host 100 and the HDD 10, the CPU 186 selects disk access according to host logical addresses (H-LBAs). That is, the CPU 186 functions as a disk access selector according to the result of the determination in block 902 and selects disk access according to host logical addresses (H-LBAs).

On the other hand, if the command is a command that does not require data transfer (No in block 902), the CPU 186 controls disk access according to the default address arrangement (block 905). That is, the CPU 186 controls disk access according to the predetermined allocation of management logical addresses (M-LBAs) to physical addresses. This causes disk access requiring no data transfer between the host 100 and HDD 10 to be provided zone by zone in the order of M-LBAs in the default address arrangement.

As described above, in the case of disk access that does not require data transfer between the host 100 and the HDD 10, the CPU 186 selects disk access that follows the allocation of management logical addresses (M-LBAs) to physical addresses. That is, the CPU 186 functions as a disk access selector according to the result of the determination in block 902 and selects disk access that follows the predetermined allocation of management logical addresses (M-LBAs) to physical addresses.

In the embodiment, physical addresses (sectors in physical addresses) to which management logical addresses (M-LBAs) are allocated in ascending order are arranged sequentially for each of head 0 to head 3 (that is, each disk surface of disks 11-0 and 11-1) as explained with reference to FIG. 7. The correspondence between the management logical addresses (M-LBAs) and the physical addresses (i.e., the default address arrangement) has nothing to do with the repetition of shingled writing. Therefore, even if physical addresses to which consecutive host logical addresses (H-LBAs) are allocated become nonconsecutive due to the repetition of shingled writing, disk access that does not require data transfer between the host 100 and the HDD 10 can be completed in a specific time.

Here, suppose disk access that requires no data transfer is disk access for a known scan test in SMART. In this case, as seen from FIG. 7, access can be provided sequentially with head 0 to head 3 in each zone and a seek operation does not take place, except for when the heads are changed. Therefore, a scan test can be executed in a specific time. Accordingly, with the embodiment, the performance of the scan test can be improved and the time required for a scan test can be estimated at high accuracy.

In block 905, the CPU 186 refers to an area corresponding to a zone to be processed at present in the PDM table 184b of FIG. 8. Here, suppose a zone to be processed at present is zone 0. FIG. 10 shows an example of the relationship between the management logical addresses (M-LBAs) and physical addresses (CHSs) shown in the default address arrangement in zone 0. Each of the physical addresses (CHSs) is indicated by cylinder number C, head number H, and sector number S as described above. As seen from FIG. 10, management logical addresses M-LBA=000 (or LBA0), M-LBA=100 (or LBA100), and M-LBA=101 (or LBA101) have been allocated to physical addresses CHS=000, CHS=00m, and CHS=00(m+1), respectively.

M-LBA=000, M-LBA=100, and M-LBA=101 are managed as primary defects in zone 0 in the PDM table 184b of FIG. 8. Here, suppose the CPU 186 controls disk access in the order of the default address arrangement of FIG. 10 in a scan test executed on, for example, zone 0 (block 905 in FIG. 9). In this case, the CPU 186 skips (or suppresses) access to M-LBA=000, M-LBA=100, and M-LBA=101 managed as primary defects in zone 0 based on the PDM table 184b of FIG. 8. More specifically, the CPU 186 skips access to physical addresses CHS=000, CHS=00m, and CHS=00(m+1) to which M-LBA=000, M-LBA=100, and M-LBA=101 have been allocated respectively.

This enables an error caused by access to a primary defect sector to be prevented in a scan test applied to the embodiment. That is, primary defect sectors can be processed properly. In the embodiment, a scan test is executed by request of the host 100. However, the scan test may be executed automatically in the HDD 10. According to at least one embodiment explained above, it is possible to provide a magnetic disk drive and a magnetic disk access method which are capable of preventing nonconsecutive physical locations on a disk from being accessed frequently in disk access that does not require data transfer between the host and the drive.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic disk drive comprising:
a disk;
a determination module configured to determine whether access to the disk requires data transfer between a host and the disk, the host configured to recognize a first plurality of logical addresses; and
a controller configured to control disk access according to a second plurality of consecutive logical addresses corresponding to physical addresses indicative of consecutive physical locations on the disk if the data transfer is not required, wherein the second plurality of logical addresses are different from the first plurality of logical addresses.

2. The magnetic disk drive of claim 1, further comprising a primary defect management table configured to manage the physical locations of primary defects in the disk based on the second plurality of logical addresses,
wherein the controller is further configured to suppress access to a physical location of a primary defect based on the primary defect management table.

3. The magnetic disk drive of claim 2, wherein disk access requested by the host for a scan test does not require data transfer between the host and disk.

4. The magnetic disk drive of claim 3, wherein:
the disk comprises a plurality of zones each comprising a plurality of areas, wherein at least one of the areas is used as a spare area; and
the second plurality of logical addresses have been allocated to consecutive physical locations on the disk based on a predetermined allocation in each of the zones.

5. The magnetic disk drive of claim 4, wherein a beginning logical address has been allocated to a beginning physical location of each of the zones as the second logical address.

6. The magnetic disk drive of claim 1, wherein the controller is further configured to control access to a physical location on the disk indicated by a physical address to which a logical address based on the first plurality of logical addresses has been allocated if access to the disk is requested by the host and data transfer is required.

7. The magnetic disk drive of claim 6, further comprising a mapping table configured to indicate the latest association between the first plurality of logical addresses and physical addresses to which the first plurality of logical addresses are allocated,
wherein the controller is further configured to determine, based on the mapping table, a physical location on the disk indicated by a physical address to which the logical address based on the first plurality of logical addresses has been allocated.

8. The magnetic disk drive of claim 7, wherein:
the disk comprises a plurality of zones each comprising a plurality of areas, wherein at least one of the areas is used as a spare area;
the second plurality of logical addresses have been allocated to consecutive physical locations on the disk based on a predetermined allocation in each of the zones; and
the controller is further configured:
to determine an area and a zone to which a physical location on the disk belongs, the physical location indicated by a physical address to which the logical address based on the first plurality of logical addresses has been allocated if the rewriting of data written on the disk is requested by the host,
to write data obtained based on merging data in the determined area with rewrite data requested by the host into the spare area in the determined zone, and
to update the mapping table so as to replace the determined area with a new spare area.

9. A method for accessing a disk in a magnetic disk drive comprising the disk, wherein the method comprises:
determining whether access to the disk requires data transfer between a host and the disk, the host configured to recognize a first plurality of logical addresses; and
accessing the disk according to a second plurality of consecutive logical addresses corresponding to physical addresses indicative of consecutive physical locations on the disk if the data transfer is not required, wherein the second plurality of logical addresses are different from the first plurality of logical addresses.

10. The method of claim 9, wherein:
the magnetic disk drive further comprises a primary defect management table configured to manage the physical locations of primary defects in the disk based on the second plurality of logical addresses; and
the method further comprises suppressing access to a physical location of a primary defect based on the primary defect management table.

11. The method of claim 10, wherein disk access requested by the host for a scan test does not require data transfer between the host and disk.

12. The method of claim 11, wherein:
the disk comprises a plurality of zones each comprising a plurality of areas, wherein at least one of the areas is used as a spare area; and
the second plurality of logical addresses have been allocated to consecutive physical locations on the disk based on a predetermined allocation in each of the zones.

13. The method of claim 12, wherein a beginning logical address has been allocated to a beginning physical location of each of the zones as the second logical address.

14. The method of claim 9, further comprising controlling access to a physical location on the disk indicated by a physical address to which a logical address based on the first plurality of logical addresses has been allocated if access to the disk is requested by the host and the data transfer is required.

15. The method of claim 14, wherein:
the magnetic disk drive further comprises a mapping table configured to indicate the latest association between the first plurality of logical addresses and physical addresses to which the first plurality of logical addresses are allocated; and
the method further comprises determining, based on the mapping table, a physical location on the disk indicated by a physical address to which the logical address based on the first plurality of logical addresses has been allocated.

16. The method of claim 15, wherein:
the disk comprises a plurality of zones each comprising a plurality of areas, wherein at least one of the areas is used as a spare area; and
the second plurality of logical addresses have been allocated to consecutive physical locations on the disk based on a predetermined allocation in each of the zones,
the method further comprising:
determining an area and a zone to which a physical location on the disk belongs, the physical location indicated by a physical address to which the logical address based on the first plurality of logical addresses has been allocated if the rewriting of data written on the disk is requested by the host;
writing data obtained based on merging data in the determined area with rewrite data requested by the host into the spare area in the determined zone; and
updating the mapping table so as to replace the determined area with a new spare area.
